(19) United States
(12) Patent Application Publication
(10) Pub. No.: US 2025/0311733 A1
(43) Pub. Date: Oct. 9, 2025

(54) PEST CONTROL COMPOSITIONS

(71) Applicants: Dow Global Technologies LLC, Midland, MI (US); Rohm and Haas Company, Collegeville, PA (US)

(72) Inventors: Caroline Woelfle-Gupta, Midland, MI (US); Selvanathan Arumugam, West Chester, PA (US); Bryan L. McCulloch, Olympia, WA (US); Susan L. Jordan, Doylestown, PA (US); Yujing Tan, Midland, MI (US)

(21) Appl. No.: 18/863,243

(22) PCT Filed: May 31, 2022
(86) PCT No.: PCT/US2022/031540

§ 371 Date: Nov. 5, 2024

(51) Int. Cl. A01N 63/23; A01N 43/647; A01P 7/04

(52) U.S. Cl. CPC A01N 63/23; A01N 43/647; A01P 7/04

(57) ABSTRACT

Embodiments are directed towards pest control compositions including a polymer, wherein the polymer includes from 0.10 wt % to 10.00 wt % of monomeric structural units derived from a benzotriazole, a benzophenone, or combinations thereof based upon a total weight of the emulsion polymer; Bacillus thuringiensis; and water.

### FIELD OF DISCLOSURE

The present disclosure generally relates to pest control compositions, and more specifically to pest control compositions including Bacillus thuringiensis.

### BACKGROUND

Pest control agents are utilized to control pests, such as insects. The effectiveness of pest control agents can be influenced by a number of factors. There is continued focus in the industry on providing new and improved pest control compositions.

### SUMMARY

According to a first feature of the present disclosure, a pest control composition includes a polymer, wherein the polymer includes from 0.10 wt % to 10.00 wt % of monomeric structural units derived from an ethylenically unsaturated monomer having a benzotriazole structural unit, an ethylenically unsaturated monomer having a benzophenone structural unit, or combinations thereof based upon a total weight of the polymer; Bacillus thuringiensis; and water. According to a second feature of the present disclosure, the polymer includes from 0.10 wt % to 1.00 wt % of monomeric structural units derived from an ethylenically unsaturated monomer having a benzotriazole structural unit, an ethylenically unsaturated monomer having a benzophenone structural unit, or combinations thereof based upon a total weight of the polymer. According to a third feature of the present disclosure, the polymer includes from 0.10 wt % to 0.50 wt % of monomeric structural units derived from an ethylenically unsaturated monomer having a benzotriazole structural unit, an ethylenically unsaturated monomer having a benzophenone structural unit, or combinations thereof based upon a total weight of the polymer. According to a fourth feature of the present disclosure, the ethylenically unsaturated monomer having the benzotriazole structural unit is 2-[2-hydroxy-5-[2-(methacryloyloxy)ethyl]phenyl]-2H-benzotriazole and the ethylenically unsaturated monomer having the benzophenone structural unit is 4-allyloxy-2-hydroxybenzophenone. According to a fifth feature of the present disclosure, the polymer includes monomeric structural units derived from methyl methacrylate, 2-ethyl hexyl acrylate, and butyl acrylate. According to a sixth feature of the present disclosure, the polymer includes from 20 wt % to 75 wt % of monomeric structural units derived from methyl methacrylate, from 5 wt % to 50 wt % of monomeric structural units derived from 2-ethyl hexyl acrylate, and from 5 wt % to 50 wt % of monomeric structural units derived from butyl acrylate based upon the total weight of the polymer. According to a seventh feature of the present disclosure, the polymer includes less than 0.5 wt % of monomeric structural units derived from a hindered amine light stabilizer.

### DETAILED DESCRIPTION

As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

All ranges include endpoints unless otherwise stated. Subscript values in polymer formulae refer to mole average values for the designated component in the polymer.

Test methods refer to the most recent test method as of the priority date of this document unless a date is indicated with the test method number as a hyphenated two-digit number. References to test methods contain both a reference to the testing society and the test method number. Test method organizations are referenced by one of the following abbreviations: ASTM refers to ASTM International (formerly known as American Society for Testing and Materials); EN refers to European Norm; DIN refers to Deutsches Institut für Normung; and ISO refers to International Organization for Standards.

As used herein, a “wt %” or “weight percent” or “percent by weight” of a component, unless specifically stated to the contrary, is based on the total weight of the composition or article in which the component is included. As used herein, all percentages are by weight unless indicated otherwise.

Pest control compositions are disclosed herein. Embodiments of the present disclosure provide that the pest control compositions include a polymer having from 0.10 wt % to 10.00 wt % of monomeric structural units derived from an ethylenically unsaturated monomer having a benzotriazole structural unit, an ethylenically unsaturated monomer having a benzophenone structural unit, or combinations thereof based upon a total weight of the polymer, Bacillus thuringiensis, and water.

The pest control compositions disclosed herein may be applied to plants, e.g., plant surfaces, to control pests. Advantageously, the pest control compositions disclosed herein can provide improved, i.e., greater, Bacillus thuringiensis activity following exposure to light, e.g., sunlight, as compared to other formulations. The greater Bacillus thuringiensis activity indicates that the pest control compositions disclosed herein can provide improved pest control, as compared to other formulations. Further, the pest control compositions disclosed herein can provide an improved, i.e., greater, remaining bacteria viability following exposure to light, e.g., sunlight, as compared to other formulations. In other words, the pest control compositions disclosed herein can provide an improved UV stability, as compared to other formulations. This greater remaining bacteria viability can help provide that the pest control compositions disclosed herein can provide improved pest control, as compared to other formulations having a relatively lesser remaining bacteria viability following exposure to light. Surprisingly, utilizing the polymer having from 0.10 wt % to 10.00 wt % of monomeric structural units derived from an ethylenically unsaturated monomer having a benzotriazole structural unit, an ethylenically unsaturated monomer having a benzophenone structural unit, or combinations thereof based upon a total weight of the polymer provides the desirable improved Bacillus thuringiensis activity and/or improved remaining bacteria viability following exposure to light.

As mentioned, the pest control compositions disclosed herein include a polymer. As used herein a “polymer” has two or more of the same or different monomeric structural units derived from two or more different monomers, e.g., copolymers, terpolymers, etc. “Monomeric structural unit”, as used herein in reference to polymers, indicates a portion of the polymer structure that results from a reaction of a monomer or monomers to form the polymer. In other words, monomeric structural units of the polymer are formed via the polymerization reaction of monomers. “Different”, in reference to monomeric structural units, indicates that the monomeric structural units differ from each other by at least one atom or are different isomerically. The polymer may be a linear polymer, a branched polymer, a crosslinked polymer, or a combination thereof.

Embodiments of the present disclosure provide that the polymer includes monomeric structural units derived from an ethylenically unsaturated monomer having a benzotriazole structural unit, an ethylenically unsaturated monomer having a benzophenone structural unit, or combinations thereof. Utilizing the polymer having monomeric structural units derived from an ethylenically unsaturated monomer having a benzotriazole structural unit, an ethylenically unsaturated monomer having a benzophenone structural unit, or combinations thereof provides the desirable improved Bacillus thuringiensis activity and/or improved remaining bacteria viability following exposure to light. An example of an ethylenically unsaturated monomer having a benzotriazole structural unit, includes, but is not limited to 2-[2-hydroxy-5-[2-(methacryloyloxy)ethyl]phenyl]-2H-benzotriazole. An example of an ethylenically unsaturated monomer having a benzophenone structural unit includes, but is not limited to, is 4-allyloxy-2-hydroxybenzophenone.

Embodiments of the present disclosure provide that the polymer includes from 0.10 wt % to 10.00 wt % of monomeric structural units derived from an ethylenically unsaturated monomer having a benzotriazole structural unit, an ethylenically unsaturated monomer having a benzophenone structural unit, or combinations thereof based upon the total weight of the polymer. For example, the polymer may have 0.10 wt % or greater, or 0.20 wt % or greater, or 0.30 wt % or greater, or 0.40 wt % or greater, or 0.45 wt % or greater, or 0.50 wt % or greater, or 0.60 wt % or greater, or 0.70 wt % or greater, or 0.80 wt % or greater, or 0.90 wt % or greater, or 1.00 wt % or greater, or 1.00 wt % or greater, or 2.00 wt % or greater, or 3.00 wt % or greater, or 4.00 wt % or greater, or 5.00 wt % or greater, or 6.00 wt % or greater, or 7.00 wt % or greater, or 8.00 wt % or greater, or 9.00 wt % or greater, while at the same time, 10.00 wt % or less, or 9.00 wt % or less, or 8.00 wt % or less, or 7.00 wt % or less, or 6.00 wt % or less, or 5.00 wt % or less, or 4.00 wt % or less, or 3.00 wt % or less, or 2.00 wt % or less, or 1.00 wt % or less, or 0.90 wt % or less, or 0.80 wt % or less, or 0.70 wt % or less, or 0.60 wt % or less, or 0.50 wt % or less, or 0.45 wt % or less, or 0.40 wt % or less, or 0.30 wt % or less, or 0.20 wt % or less, or less of the monomeric structural units derived from an ethylenically unsaturated monomer having a benzotriazole structural unit, an ethylenically unsaturated monomer having a benzophenone structural unit, or combinations thereof based upon the total weight of the polymer. Unless otherwise defined herein, the wt % of the monomeric structural units and their chemical identity is determined via ¹H Nuclear Magnetic Resonance end-group analysis spectroscopy.

One or more embodiments of the present disclosure provide that the polymer includes monomeric structural units derived from an acrylic monomer. As used herein “acrylic” refers to ethylenically unsaturated carboxylic acid and ethylenically unsaturated carboxylic acid derivatives, e.g., acrylic includes methacrylic. Examples of carboxylic acid derivatives include esters, amides, and anhydrides. Examples of acrylic esters include, but are not limited to methyl methacrylate, ethyl acrylate, butyl acrylate, 2-ethylhexyl acrylate, butyl methacrylate, dimethylaminoethyl methacrylate, hydroxyethyl acrylate, hydroxypropyl acrylate, glycidyl methacrylate, trimethylolpropane triacrylate, and combinations thereof.

Embodiments of the present disclosure provide that the polymer includes from 50.00 wt % to 99.80 wt % of monomeric structural units derived from an acrylic ester based upon a total weight of the polymer. All individual values and subranges from 50.00 wt % to 99.80 wt % are included; for example, the polymer can include from a lower limit of 50.00 wt %, 60.00 wt %, or 70.00 wt % to an upper limit 99.80 wt %, 99.50 wt %, or 99.00 wt % of monomeric structural units derived from an acrylic ester based upon the total weight of the polymer.

One or more embodiments of the present disclosure provide that the polymer can include from 20 wt % to 75 wt % of monomeric structural units derived from methyl methacrylate. All individual values and subranges from 20 wt % to 75 wt % are included; for example, the polymer can include from a lower limit of 20 wt %, 30 wt %, or 40 wt % to an upper limit 75 wt %, 65 wt %, or 55 wt % of monomeric structural units derived from methyl methacrylate based upon the total weight of the polymer.

One or more embodiments of the present disclosure provide that the polymer can include from 5 wt % to 50 wt % of monomeric structural units derived from 2-ethyl hexyl acrylate. All individual values and subranges from 5 wt % to 50 wt % are included; for example, the polymer can include from a lower limit of 5 wt %, 10 wt %, or 15 wt % to an upper limit 50 wt %, 40 wt %, or 30 wt % of monomeric structural units derived from 2-ethyl hexyl acrylate based upon the total weight of the polymer.

One or more embodiments of the present disclosure provide that the polymer can include from 5 wt % to 50 wt % of monomeric structural units derived from butyl acrylate. All individual values and subranges from 5 wt % to 50 wt % are included; for example, the polymer can include from a lower limit of 5 wt %, 10 wt %, or 15 wt % to an upper limit 50 wt %, 40 wt %, or 30 wt % of monomeric structural units derived from butyl acrylate based upon the total weight of the polymer.

One or more embodiments of the present disclosure provide that the polymer can include monomeric structural units derived from vinyl esters. Examples of vinyl esters include, but are not limited to vinyl acetate, vinyl caprate, vinyl propionate, vinyl ester of versatic acid, and combinations thereof.

One or more embodiments of the present disclosure provide that the polymer can include from 0.5 wt % to 20.0 wt % of monomeric structural units derived from vinyl esters. All individual values and subranges from 0.5 wt % to 20.0 wt % are included; for example, the polymer can include from a lower limit of 0.5 wt %, 1.0 wt %, or 5.0 wt % to an upper limit 20.0 wt %, 15.0 wt %, or 10 wt % of monomeric structural units derived from vinyl esters based upon the total weight of the polymer.

One or more embodiments of the present disclosure provide that the polymer can include monomeric structural units derived from acid monomers such as itaconic acid, fumaric acid, crotonic acid, acrylic acid, methacrylic acid, maleic acid, acryloxypropionic acid, citraconic acid. One or more embodiments of the present disclosure provide that the polymer can include from 0.1 wt % to 10.0 wt % of monomeric structural units derived from acid monomers. All individual values and subranges from 0.1 wt % to 10.0 wt % are included; for example, the polymer can include from a lower limit of 0.1 wt %, 0.5 wt %, or 1.0 wt %, wt% to an upper limit 10.0 wt %, 5.0 wt %, or 3.0 wt % of monomeric structural units derived from acid monomers based upon the total weight of the polymer.

One or more embodiments of the present disclosure provide that the polymer can include monomeric structural units derived from an additional monomer. Examples of additional monomers include, but are not limited to, styrene, maleic anhydride, vinyl toluene, butadiene, ethylene, isobutylene, diisobutylene, acrylonitrile, vinyl chloride, vinylidene chloride, vinyl pyridine, acrylamide, n-methylolacrylamide, and combinations thereof. Further examples of additional monomers include adhesion promoting monomers, such as ureido methacrylate, for instance, and cross-linking monomers, such as divinyl benzene, allyl methacrylate, diallyl phthalate, trimethylol propane triacrylate, 1,6-hexanediol diacrylate, ethylene glycol diacrylate, ethylene glycol dimethacrylate, and combinations thereof, for instance.

One or more embodiments of the present disclosure provide that the polymer can include from 0.5 wt % to 20.0 wt % of monomeric structural units derived from the additional monomer. All individual values and subranges from 0.5 wt % to 20.0 wt % are included; for example, the polymer can include from a lower limit of 0.5 wt %, 1.0 wt %, or 5.0 wt % to an upper limit 20.0 wt %, 15.0 wt %, or 10 wt % of monomeric structural units derived from an additional monomer based upon the total weight of the polymer. One or more embodiments of the present disclosure provide that the polymer can include from 0.1 wt % to 5 wt % of monomeric structural units derived from an adhesion promoting monomer. One or more embodiments of the present disclosure provide that the polymer can include from 0.1 wt % to 5 wt % of monomeric structural units derived from a cross linking monomer.

One or more embodiments of the present disclosure provide that the polymer includes less than 0.5 wt % of monomeric structural units derived from a hindered amine light stabilizer. For instance, the polymer can include from a lower limit of 0.001 wt %, 0.01 wt %, or 0.1 wt % to an upper limit of 0.4 wt %, 0.3 wt %, or 0.2 wt % of monomeric structural units derived from a hindered amine light stabilizer based upon the total weight of the polymer. One or more embodiments of the present disclosure provide that the polymer does not include monomeric structural units derived from a hindered amine light stabilizer. Examples of hindered amine light stabilizers include, but are not limited to 2,2,6,6-tetramethyl-4-piperidyl methacrylate, 1,2,2,6,6-pentamethyl-4-piperidyl methacrylate, and combinations thereof. While not intending to be bound to theory, including particular wt % of monomeric structural units derived from a hindered amine light stabilizer in the polymer may undesirably reduce the improved Bacillus thuringiensisactivity and/or improved remaining bacteria viability following exposure to light as discussed herein.

Embodiments of the present disclosure provide that the polymer has a weight average molecular weight (Mw) from 10,000 daltons to 3,000,000 daltons. All individual values and subranges from 10,000 daltons to 3,000,000 daltons are included; for example, the polymer may have a Mw from a lower limit of 10,000 daltons, 25,000 daltons, or 50,000 daltons to an upper limit of 3,000,000 daltons, 2,500,000 daltons, or 2,000,000 daltons as measured according to gel permeation chromatography.

Embodiments of the present disclosure provide that the polymer has an average particle diameter from 30 nanometers to 10 microns. All individual values and subranges from 30 nanometers to 10 microns are included; for example, the polymer may have an average particle diameter from a lower limit of 30, 40, or 50 nanometers to an upper limit 10, 5, or 2 microns.

The polymer may be formed via emulsion polymerization. In emulsion polymerization, an emulsion containing the polymer can be prepared by emulsion polymerization, e.g., known emulsion polymerization processes. The emulsion polymerization can be performed at a pH of 5.0 or less using free-radical producing initiators, which may be utilized in an amount from 0.01 wt % to 5 wt % based on a total weight of the monomers, for instance.

Free-radical producing initiators include, but are not limited to peroxygen compounds, 2,2′-azobisisobutyronitrile, and high energy radiation sources. Examples of peroxygen compounds include inorganic persulfate compounds such as ammonium persulfate, potassium persulfate, sodium persulfate; peroxides such as hydrogen peroxide; organic hydroperoxides, for example, cumene hydroperoxide, and t-butyl hydroperoxide; organic peroxides, for example, benzoyl peroxide, acetyl peroxide, lauroyl peroxide, peracetic acid, and perbenzoic acid, which may be activated by a water-soluble reducing agent such as ferrous compound or sodium bisulfite.

The emulsion polymerization can include one or more emulsifiers. Examples of emulsifiers include, but are not limited to anionic surfactants, nonionic surfactants, amphoteric surfactants, and zwitterionic surfactants. Examples of anionic emulsifiers include alkali metal alkyl aryl sulfonates, alkali metal alkyl sulfates, and sulfonated alkyl esters, among others. Specific examples of emulsifiers are sodium dodecylbenzenesulfonate, sodium disecondary-butylnaphthalene sulfonate, sodium lauryl sulfate, disodium dodecyldiphenyl ether disulfonate, disodium n-octadecylsulfosuccinamate and sodium dioctylsulfosuccinate. Examples of nonionic emulsifiers include structures based on polyethylene oxide or oligosaccharides hydrophilic heads, among others. Various amounts or emulsifier may be utilized for different applications.

Optionally, other ingredients known for emulsion polymerizations may be utilized, such as chelating agents, buffering agents, inorganic salts, and pH adjusting agents, among others. Various amounts of other ingredients may be utilized for different applications.

Embodiments of the present disclosure provide that the emulsion containing the polymer can have a solids content from 10 wt % to 60 wt %, based upon a total weight of the emulsion containing the polymer. All individual values and subranges from 10 wt % to 60 wt % are included; for example, the emulsion containing the polymer can have a solids content from a lower limit of 10 wt %, 12 wt %, or 15 wt % to an upper limit of 60 wt %, 55 wt %, or 45 wt % based upon the total weight of the emulsion containing the polymer. One or more embodiments provide that the emulsion containing the polymer is an aqueous dispersion.

Embodiments of the present disclosure provide that the emulsion containing the polymer can have a pH of 6 or lower. For instance, the emulsion containing the polymer can have a pH from a lower limit of 1.0, 1.5, or 2.0 to an upper limit of 6.0, 5.7, or 5.5.

The pest control compositions disclosed herein include Bacillus thuringiensis. As defined herein, “Bacillus thuringiensis” is defined as the spores and/or the crystallized proteins of the species Bacillus thuringiensis and includes all Bacillus thuringiensis subspecies exhibiting insecticidal properties. Examples of such subspecies include kurstaki, israelensis and aizawa. The Bacillus thuringiensis may be added to the pesticide formulation as either a solid or as part of a liquid formulation. The presence and subspecies of Bacillus thuringiensis is determined by Random Amplified Polymorphic DNA analysis. A commercially available liquid formulation of Bacillus thuringiensis is THURICIDE™ pesticide available from CERTIS USA, Columbia, Maryland.

Bacillus thuringiensis can produce insecticidal crystal proteins, e.g., Cry proteins and Cyt proteins, by sporulation. A greater remaining bacteria viability, following exposure to light, can provide desirably improved pest control, as compared to other formulations.

One or more embodiments of the present disclosure provide that the pest control compositions disclosed herein can include an additive. Examples of additives include rheology modifiers, dispersants, wetting aids, anti-oxidants, surfactants, co-solvents, coalescents, defoamers, preservatives, flow agents, leveling agents, slip additives, neutralizing agents, viscosity modifiers, pH modifiers, herbicides, fungicides, and combinations thereof, among others. Different amount of the additive may be utilized for various applications.

As mentioned, the pest control compositions disclosed herein include the polymer. The polymer can be from 0.1 wt % to 15.0 wt % of the pest control composition based upon a total weight of a combination of the polymer, the Bacillus thuringiensis, and the water. All individual values and subranges from 0.1 to 15.0 wt % are included; for example, the pest control composition can include the polymer from a lower limit of 0.1 wt %, 0.5 wt %, or 1.0 wt % to an upper limit of 15 wt %, 12 wt %, or 10 wt % based upon the total weight of the combination of the polymer, the Bacillus thuringiensis, and the water.

The pest control compositions disclosed herein include the Bacillus thuringiensis. The Bacillus thuringiensis can be from 0.01 wt % to 25.00 wt % of the pest control composition based upon a total weight of a combination of the polymer, the Bacillus thuringiensis, and the water. All individual values and subranges from 0.01 wt % to 25.00 wt % are included; for example, the pest control composition can include the Bacillus thuringiensis from a lower limit of 0.01 wt %, 0.05 wt %, or 1.0 wt % to an upper limit of 25.00 wt %, 15.00 wt %, or 10.00 wt % based upon the total weight of the combination of the polymer, the Bacillus thuringiensis, and the water.

The pest control compositions disclosed herein include water. The water can be from 60.00 wt % to 99.89 wt % of the pest control composition based upon a total weight of a combination of the polymer, the Bacillus thuringiensis, and the water. All individual values and subranges from 60.00 wt % to 99.89 wt % are included; for example, the pest control composition can include the water from a lower limit of 60.00 wt %, 65.00 wt %, or 70.00 wt % to an upper limit of 99.89 wt %, 98.00 wt %, or 95.00 wt % based upon the total weight of the combination of the polymer, the Bacillus thuringiensis, and the water. The water may be incorporated into the pest control compositions via the emulsion containing the polymer and/or the water may be incorporated into the pest control composition by addition that is independent of the emulsion.

The pest control compositions disclosed herein can be formed using known equipment and processes. The components of the pest control compositions may be combined, e.g., mixed, to form the pest control compositions. For instance, the components of the pest control compositions may be added to a vessel and be agitated therein. The components of the pest control compositions may be combined in any order.

The pest control compositions disclosed herein may be applied to plants, e.g., plant surfaces, to control pests. The pest control compositions may be applied to plants using known equipment and processes. For instance, the pest control compositions may be sprayed, sprinkled, and/or poured, among other applications, to plants. Different amounts of the pest control composition may be applied to plants for various applications.

The pest control compositions may be applied to plants using known equipment and processes. For instance, the pest control compositions may be sprayed, sprinkled, and/or poured, among other applications, to plants. Different amounts of the pest control composition may be applied to plants for various applications.

### EXAMPLES

In the Examples, various terms and designations for materials are used including, for instance, the following:

Methyl methacrylate (monomer, obtained from Sigma-Aldrich); 2-ethyl hexyl acrylate (monomer, obtained from Sigma-Aldrich); butyl acrylate (monomer, obtained from Sigma Aldrich); methacrylic acid (monomer, obtained from Sigma-Aldrich); ureido methacrylate (adhesion promoting monomer, obtained from The Dow Chemical Company); 2-[2-hydroxy-5-[2-(methacryloyloxy)ethyl]phenyl]-2H-benzotriazole (ethylenically unsaturated monomer having a benzotriazole structural unit, CAS Number 96478-09-0, obtained from Sigma-Aldrich); 4-allyloxy-2-hydroxybenzophenone (ethylenically unsaturated monomer having a benzophenone structural unit, CAS Number 2549-87-3, obtained from Sigma-Aldrich); 2,2,6,6-tetramethyl-4-piperidyl methacrylate (hindered amine light stabilizer, CAS Number 31582-45-3, obtained from Sigma-Aldrich), 1,2,2,6,6-pentamethyl-4-piperidyl methacrylate (hindered amine light stabilizer, CAS Number 68548-08-3, obtained from Sigma-Aldrich), 2-(2-hydroxy-5-methylphenyl) benzotriazole (benzotriazole, CAS Number 2440-22-4, obtained from Sigma-Aldrich); THURICIDE™ (Bacillus thuringiensis, liquid formulation, manufactured by Certis).

Example 1, a pest control composition, was formed as follows. Methyl methacrylate (46.15 wt %), 2-ethyl hexyl acrylate (26.7 wt %), butyl acrylate (21.7 wt %), methacrylic acid (2.5 wt %), ureido methacrylate (2.5 wt %), and 2-[2-hydroxy-5-[2-(methacryloyloxy)ethyl]phenyl]-2H-benzotriazole (0.45 wt %) formed a polymer via emulsion polymerization; the emulsion product contained 48.2 wt % of polymer solids. The polymer was diluted with deionized water to provide a solution of 2.5 wt % polymer solids in water. The polymer solution (2.5 wt % in water, 1.86 mL), THURICIDE™ (0.93 mL), and water (10.21 mL) were combined to provide Example 1. The emulsion polymerization was performed by adding deionized water (900 grams), sodium carbonate (7.02 grams), and RHODAFAC™ RS-610 A-25 (91.2 grams, 25 wt % active) to a 4-neck 5000 mL glass flask reactor equipped with condenser, overhead mixing, heating mantle and nitrogen sweep. A monomer emulsion was made by combining deionized water (675 grams), 17.4g of RHODAFAC™ RS-610 (17.4 grams), butyl acrylate (380.6 grams), 2-ethylhexyl acrylate (467.1 grams), 817.4g methyl methacrylate (817.4 grams), 43.3g methacrylic acid (43.3 grams), 21.6g of ureido methacrylate (21.6 grams), and 2-[2-Hydroxy-5-[2-(methacryloyloxy)ethyl]phenyl]-2H-benzotriazole (8 grams). After heating the reactor to 85° C., the monomer emulsion (108.6 grams) and ammonium persulfate (5.27 grams) were added to the reactor. The reaction temperature was held at 88° C. and the remaining monomer emulsion was fed into the reactor over 70 minutes. Then, aqueous tert-butyl hydroperoxide solution (0.18 grams, 70 wt % in water) and water (17 grams) were added to the reactor followed by a solution of iso-ascorbic acid (0.08 grams), Versene EDTA solution (1.76 grams, 1 wt %) and iron (II) sulfate solution (0.35 grams, 5 wt % in water). The reactor contents were cooled to 75° C. and then tert-butyl hydroperoxide solution (1.76 grams, 70 wt % in water), water (20 grams), and iso-ascorbic solution (0.88 grams) were added over 20 minutes. Then the reactor contents were cooled to room temperature and ammonium hydroxide solution (11.5 grams, 28 wt % in water) and 15g of water (15 grams) were added and the reactor contents was filtered through a 100 mesh screen to provide the emulsion product.

Example 2, a pest control composition, was formed as Example 1 with the change that 4-allyloxy-2-hydroxybenzophenone (0.45 wt % based on a total weight of monomers) was utilized rather than the 2-[2-hydroxy-5-[2-(methacryloyloxy)ethyl]phenyl]-2H-benzotriazole.

Comparative Example A was formed as Example 1 with the change that 2,2,6,6-tetramethyl-4-piperidyl methacrylate (0.3 wt % based on a total weight of monomers) was utilized rather than the 2-[2-hydroxy-5-[2-(methacryloyloxy)ethyl]phenyl]-2H-benzotriazole, and methyl methacrylate (46.0 wt % based on a total weight of monomers) was utilized.

Comparative Example B was formed as Example 1 with the change that 4-allyloxy-2-hydroxybenzophenone (0.3 wt % based on a total weight of monomers) and 2,2,6,6-tetramethyl-4-piperidyl methacrylate (0.45 wt %) was utilized rather than the 2-[2-hydroxy-5-[2-(methacryloyloxy)ethyl]phenyl]-2H-benzotriazole, and methyl methacrylate (45.4 wt % based on a total weight of monomers) was utilized.

Comparative Example C was formed as follows. 2-(2-hydroxy-5-methylphenyl) benzotriazole (0.01 grams), THURICIDE™ (0.93 mL), and water (10.21 mL) were combined to provide Comparative Example C.

Comparative Example D was formed as follows. THURICIDE™ (0.93 mL) and water (10.21 mL) were combined to provide Comparative Example D.

Bacillus thuringiensis activities before and after exposure to light for Examples 1-2 and Comparative Examples A-D were determined as follows. An auto-pipettor was used to place respective 30 μL drops of Examples 1-2 and Comparative Examples A-D on a plastic petri dish; the drops were dried for approximately 1 hour. The dried drops were exposed to light at 35 milliwatts/cm² for 2 hours. The samples were extracted and plated. For extraction, each of the samples was placed in 1 wt % solution of TWEEN™ 20 solution and incubated for approximately 12 hours. For plating, the samples were diluted to a desired starting concentration, using a 0.1 wt % solution of TWEEN™ 20 then serially diluted at suitable concentrations and plated evenly in 10 μL drops. The plates were then held in an incubator at 30° C. for approximately 12 hours. Thereafter, the number of colonies were counted and expressed as log colony forming units/mL, while accounting for dilution factors. The percentage of viable Bacillus thuringiensis retained was calculated. The results are reported in Table 1.

TABLE 1

| | Bacillus | Bacillus | Percentage |
|---|---|---|---|
| | thuringiensis | thuringiensis | of viable |
| | activity | activity | bacillus |
| | before light exposure | after light exposure | thuringiensis |
| | (log CFU/mL) | (log CFU/mL) | retained |
| Example 1 | 9.08 ± 0.10 | 4.65 ± 0.13 | 51% |
| Example 2 | 9.24 ± 0.09 | 5.41 ± 0.13 | 59% |
| Comparative | 9.14 ± 0.12 | 0 | 0% |
| Example A | | | |
| Comparative | 9.00 ± 0.14 | 0 | 0% |
| Example B | | | |
| Comparative | 8.86 ± 0.12 | 0 | 0% |
| Example C | | | |
| Comparative | 8.85 ± 0.04 | 0 | 0% |
| Example D | | | |

The data of Table 1 illustrates that both of Examples 1-2 have an improved Bacillus thuringiensis activity after light exposure as compared to each of Comparative Examples A-D. Also, the data of Table 1 illustrates that both of Examples 1-2 have an improved, i.e. greater, percentage of viable Bacillus thuringiensis retained, as compared to each of Comparative Examples A-D.

1. A pest control composition comprising:
A polymer comprising from 0.10 wt % to 10.00 wt % of monomeric structural units derived from an ethylenically unsaturated monomer having a benzotriazole structural unit, an ethylenically unsaturated monomer having a benzophenone structural unit, or combinations thereof based upon a total weight of the polymer;
Bacillus thuringiensis; and
water.

2. The pest control composition of claim 1, wherein the polymer includes from 0.10 wt % to 1.00 wt % of monomeric structural units derived from an ethylenically unsaturated monomer having a benzotriazole structural unit, an ethylenically unsaturated monomer having a benzophenone structural unit, or combinations thereof based upon a total weight of the polymer.

3. The pest control composition of claim 2, wherein the polymer includes from 0.10 wt % to 0.50 wt % of monomeric structural units derived from an ethylenically unsaturated monomer having a benzotriazole structural unit, an ethylenically unsaturated monomer having a benzophenone structural unit, or combinations thereof based upon a total weight of the polymer.

4. The pest control composition of any one of claim 1, wherein the ethylenically unsaturated monomer having the benzotriazole structural unit is 2-[2-hydroxy-5-[2-(methacryloyloxy)ethyl]phenyl]-2H-benzotriazole and the ethylenically unsaturated monomer having the benzophenone structural unit is 4-allyloxy-2-hydroxybenzophenone.

5. The pest control composition of any one of claim 1, wherein the polymer includes monomeric structural units derived from methyl methacrylate, 2-ethyl hexyl acrylate, and butyl acrylate.

6. The pest control composition of claim 5, wherein the polymer includes from 20 wt % to 75 wt % of monomeric structural units derived from methyl methacrylate, from 5wt % to 50 wt % of monomeric structural units derived from 2-ethyl hexyl acrylate, and from 5 wt % to 50 wt % of monomeric structural units derived from butyl acrylate based upon the total weight of the polymer.

7. The pest control composition of any one of claim 1, wherein the polymer includes less than 0.5 wt % of monomeric structural units derived from a hindered amine light stabilizer.
